(19) United States
(12) Patent Application Publication
(10) Pub. No.: US 2013/0056484 A1
(43) Pub. Date: Mar. 7, 2013

(54) INSULATED CUP AND A COVER SHEET THEREFOR

(71) Applicants: Wei Lu, Dublin (IE); Kenneth Duggan, Dublin (IE)

(72) Inventors: Wei Lu, Dublin (IE); Kenneth Duggan, Dublin (IE)

(73) Assignee: HANPAK LIMITED, County Laois (IE)

(21) Appl. No.: 13/637,543

(22) PCT Filed: Nov. 25, 2009
(86) PCT No.: PCT/EP2009/065856

§ 371 Date: Sep. 26, 2012

(51) Int. Cl. B65D 25/22; B31B 49/00

(52) U.S. Cl. 220/739; 493/374

(57) ABSTRACT

A thermally insulated cup (1, 20, 30) made from paperboard, the cup comprising a tubular wall (3), a closed base (5) at a lower end (11) and an open top (6) defined at an upper end (12). A cover sheet (7, 70) made from paper or paperboard, preferably recycled, is wrapped around the tubular wall. The cover sheet has an outer face (71) and an inner face (72). A multi-ply sheet (8) of tissue paper is placed intermediate the inner face of the cover sheet and the tubular wall so that the sheet of tissue paper also wraps the tubular wall. The sheet of tissue paper is positioned under grippable areas of the cover sheet to provide enhanced thermal insulation of the grippable areas. The cover sheet is releasably fastened to the tubular wall so that the tissue paper can be easily removed and used for its direct purpose, e.g. wiping a surface.

### FIELD OF THE INVENTION

The present invention relates to a cup for cold and hot beverages or food and in particular to a disposable cup, more specifically to an insulated disposable cup, and an insulating cover sheet therefor.

### BACKGROUND OF THE INVENTION

Disposable cups are widely used nowadays in the fast food industry for holding hot or cold beverages or hot or cold food. Thermal insulation of the cup walls is often required to maintain the temperature of the contents of the cup and/or to prevent the user from burning his/her fingers or from experiencing discomfort when holding a hot or a cold cup. Known disposable cups made from polystyrene provide a very good thermal insulation of the contents of the cup but are not environmentally friendly. Disposable cups made from paperboard are relatively easily recyclable and therefore are environmentally benign but insulating properties of paperboard are not as good as those of polystyrene. Multi-layer paperboard cups are known in which the cup wall is composed of two or more layers of paperboard, or a combination of layers of paperboard and plastics. The manufacturing process for such cups is far more complicated than that of an ordinary single-layer cup. Multi-layer cups are more expensive because more material is used in their manufacture. They also produce more waste since twice or even thrice the volume of paperboard is used in a multi-layer cup which needs to be disposed of after the use of the cup. Alternatively, a separate insulating ring or sleeve which includes a layer of corrugated paperboard can be placed around the wall of a single-layer paperboard cup to form an additional layer of insulation. Typically a supply of insulating rings needs to be maintained available for a user near the supply of cups at the vending location. Maintaining a stock of insulating rings involves additional expense, requires additional storage space and managerial resources. Due to the incessant popularity of fast food services, enormous amounts of insulated disposable cups are being used and discarded all over the world on a daily basis, while still has not been proposed a satisfactory solution to reduce the cost of manufacturing and recycling such cups.

In view of the above, it is an object of the present invention to alleviate and mitigate the disadvantages of the prior art and to provide an improved insulated disposable cup which is easy and inexpensive to manufacture, environmentally and user friendly.

### SUMMARY OF THE INVENTION

Accordingly, the present invention provides a thermally insulated cup made from a material which is sufficiently rigid to retain its shape while holding the contents of the cup, the cup comprising a tubular wall having a central longitudinal axis, a closed base at a lower end and an open top defined at an upper end of the cup, and

a cover sheet configured to be placed around the tubular wall of the cup, the cover sheet comprising an outer face and an inner face and a grippable area on the outer face;

wherein a multi-ply sheet of tissue paper is provided at the inner face of the cover sheet so that when the cover sheet is placed around the tubular wall of the cup, the tissue paper is located intermediate the inner face of the cover sheet and the tubular wall so that the sheet of tissue paper wraps the tubular wall.

Ideally, the sheet of tissue paper is sized so that on the one hand it is confined within the boundaries of the cover sheet, and on the other hand the size of the sheet of tissue paper is such that a layer of the tissue paper is present under the grippable area of the cover sheet.

Ideally, the material of the cup is paperboard.

It will be appreciated that the terms “inner”, “inwardly”, “outer”, “outwardly”, “longitudinal”, etc. are used in relation to the central longitudinal axis of the tubular wall of the cup. It will also be appreciated that the terms “up”, “upper” “upright”, “down”, “lower” downward”, etc. are used in relation to the base of the cup.

The arrangement of the present invention provides a regular cup, e.g. a paperboard cup with an inexpensive, easily manufactured and environmentally friendly layer of thermal insulation. Tissue paper typically comprises one or more plies of very thin, lightweight, delicate paper. In the cup of the present invention, the sheet of tissue paper comprises several plies and/or is folded to increase the number of plies. Due to the presence of air between the plies, when the sheet of tissue paper is interposed between the cover sheet and the tubular wall of the cup, the sheet of tissue paper provides the cup with excellent thermal insulation properties. Additionally, the cup of the present invention is pleasant to grip because the tissue paper provides a cushioning effect due to the presence of the air between the plies of the tissue paper. In one arrangement, the sheet of tissue paper comprises sufficient number of plies to provide thermal insulation without being folded. In another possible variation, the sheet of tissue paper is larger than the cover sheet and is folded to reduce its size so that it is confined within the boundaries of the cover sheet when the sheet of tissue paper is interposed between the cover sheet and the tubular wall, thereby also increasing the number of plies and as a result enhancing the insulating properties of the cup.

A substantial advantage of the present invention resides in that while providing excellent inexpensive and environmentally friendly layer of insulation, the sheet of tissue paper can be removed from underneath the cover sheet when required or desired and used for its direct purpose, namely personal hygiene or wiping a surface. The tissue paper may be removed for use for its direct purpose when the insulating properties of the cup are no longer required, e.g. when the cup contents has reached a comfortable for the user temperature or when the user does not need to hold the cup for a time interval long enough to cause a thermal discomfort or, indeed, at any time when required or desired by a user. The cover sheet is preferably configured to be capable of being re-placed into the position in which it wraps the tubular wall.

Preferably, the cover sheet comprises a portion pivotable about a hinge to enable at least a portion of the cover sheet to be pivoted to and from the tubular wall.

In one embodiment, the cover sheet comprises an upper edge, a lower edge and a pair of longitudinal edges defining the perimeter of the cover sheet.

In one arrangement, at least a first portion of the cover sheet, preferably adjacent a first longitudinal edge, is hingedly secured to the tubular wall; and wherein at least a second portion of the cover sheet, preferably adjacent at least the second longitudinal edge, is releasably fastened to the tubular wall or the cover sheet via a fastening means. In this arrangement, in order to remove the tissue paper, the second portion of the cover sheet is unfastened and the cover sheet is pivoted about the hinge at the first portion so as to distance the inner face of the cover sheet from the tubular wall of the cup sufficiently to enable the user remove the tissue paper. In a preferred variation, the releasable fastening means is re-fastenable to the tubular wall of the cup. Accordingly, the cover sheet can be re-placed into the position in which it wraps the tubular wall by pivoting the cover sheet in the reverse direction and re-fastening the second portion of the cover sheet to the tubular wall.

In a preferred arrangement, the upper and the lower edges of the cover sheet are also releasably and, ideally, re-fastenably fastened to the tubular wall. Due to such an arrangement, the cleanliness of the sheet of tissue paper is maintained uncompromised until the cover sheet is unfastened for the first time form the tubular wall.

It will be appreciated that many ways of releasably and re-fastenably fastening the cover sheet to the tubular wall would be apparent to a person skilled the art. One possible preferred way of fastening the cover sheet to the tubular wall is by providing a layer of a pressure-sensitive peelable and re-sealable adhesive, preferably made from a renewable material, on the inner face of the cover sheet on or adjacent the second portion of the cover sheet or on the corresponding area of the tubular wall.

It will be appreciated that the invention is not limited to the use of a peelable and re-sealable adhesive, and that the use of a permanent adhesive is also envisaged, in which case the fastened portion of the cover sheet is unfastened by permanently breaking the adhesive bond between the inner face of the cover sheet and the tubular wall or by tearing off the portions of the cover sheet adhered to the inner wall.

In one variation, the required portions of the cover sheet can be fastened to the tubular wall by one or more adhesive strips, which are preferably peelable and re-sealable, but without limiting the invention thereto.

In a further variation, the second portion of the cover sheet is releasably fastened to the tubular wall by fastening the second portion to the first portion of the cover sheet which itself is at least partially fastened to the tubular wall.

In a further variation, the first portion of the cover sheet is hingedly secured to the tubular wall by fastening the first portion of the cover sheet to the tubular wall and by forming a hinge in the form of a fold line in the cover sheet extending along the fastened region of the first portion of the cover sheet. In one arrangement, the first portion of the cover sheet is fastened to the tubular wall using an adhesive, for example, but not limited thereto, a pressure-sensitive peelable and re-sealable adhesive, or a permanent, i.e. non-peelable adhesive applied to the inner face of the cover sheet. It will be appreciated that a number of ways of hingedly fastening the required portions of the cover sheet to the tubular wall would be apparent to a person skilled in the art.

In a most preferred arrangement, the material of the cover sheet is made from a recycled material and comprises, for example, recycled paper or recycled paperboard, thereby rendering the cup of the present invention even less expensive and more environmentally friendly. Ideally, the cover sheet is made from a material more flexible than the material of the tubular wall and which is preferably thinner than the material (e.g. paperboard) of which the cup is made. Accordingly, less material is required to manufacture the cup of the invention and, as a result, the cup of the present invention is less expensive than a known multi-layer cup made entirely from the same material. Furthermore, because less material is used, the cup of the invention is easier and less expensive to dispose of after use and recycle.

The thickness of the material of the cover sheet is sufficient to provide the cup with thermal insulation properties if not as substantial as those provided for by the combination of the cover sheet and the sheet of tissue paper but nevertheless greater than provided for by the material of the tubular wall alone and sufficient to prevent the user from experiencing thermal discomfort while holding the cup of the invention. For example, the user can initially purchase a hot or cold beverage or food in a cup in accordance with the invention. The combination of the cover sheet and the sheet of tissue paper enable the user to grip the cup and carry it to the location of consumption, e.g. workplace or home, without burning the user's fingers. By the time the user reaches the location of consumption, the temperature of the contents of the cup typically changes so that it no longer causes thermal discomfort to the user in the absence of the sheet of tissue paper. In this case, the portions of the cover sheet releasably fastened to the tubular wall can be unfastened as described above and the cover sheet can be pivoted about the hinge at the first portion of the cover sheet to enable the user remove the sheet of tissue paper from its position intermediate the tubular wall and the cover sheet. Upon removal of the tissue paper, the cover sheet is re-fastened to the tubular wall as described above. The thermal insulation provided by the combination of the cup material (e.g. paperboard) and the cover sheet without the tissue paper is in this case sufficient to prevent the user from experiencing thermal discomfort while holding the cup of the invention.

The sheet of tissue paper need not necessarily be secured to the cover sheet or the tubular wall since it is held in its position intermediate the cover sheet and the tubular wall due to friction forces between the tissue paper and each of the cover sheet and the tubular wall. In one preferred arrangement however, the sheet of tissue paper is releasably secured to the cover sheet or the tubular wall of the cup by a securing means so that the sheet of tissue paper can be easily removed from its position intermediate the cover sheet and the tubular wall without damaging the tissue paper. For example, in one modification, a pocket or tab or bracket members are formed at the inner face of the cover sheet or on the outwardly facing face of the tubular wall suitably shaped for holding the sheet of tissue paper. In an alternative variation, the sheet of tissue paper is held secured to the inner face of the cover sheet or on the outwardly facing face of the tubular wall by adhesive tabs or strips. Such a tab or a strip is partially adhered to the sheet of tissue paper and partially peelably adhered to the inner face of the cover sheet or the outwardly facing face of the tubular wall. In one preferred arrangement, the sheet of tissue paper is adhered to the inner face of the cover sheet of the outwardly facing face of the tubular wall by a layer of an adhesive provided between the sheet of tissue paper and the cover sheet or the outwardly facing face of the tubular wall. Ideally, the adhesive force is such that it is sufficient to hold the sheet of tissue paper attached to the cover sheet or the tubular wall, respectively, but is sufficiently weak so that the sheet of tissue paper can be separated from the cover sheet or the tubular wall without being damaged. It will be appreciated that a number of ways of releasably securing the sheet of tissue paper to the inner face of the cover sheet or on the outwardly facing face of the tubular wall would be readily apparent to a person skilled in the art.

In a further modification of the cup of the invention, the tubular wall of the cup is formed by a pair of concentric tubular layers an outer layer and an inner layer radially spaced apart to define an insulation gap therebetween. In one arrangement, the cover sheet comprises the outer layer. In another arrangement, a window is formed in the outer layer, the area of the window being greater than the area of the remaining outer layer material. The window and the cover sheet are mutually sized and shaped so that the cover sheet covers the window when the cover sheet wraps the tubular wall of the cup, wherein the first portion of the cover sheet is hingedly secured to the to the remaining material of the outer layer and wherein the second portion of the cover sheet is releasably fastened to the remaining material of the outer layer via a fastening means. Such an arrangement renders a double-wall cup less expensive to manufacture, more environmentally friendly and easier and less expensive to dispose of and to recycle. In these arrangements, the sheet of tissue paper is preferably accommodated in the gap defined between the inner layer of the tubular wall of the cup and the inner face of the cover sheet. The latter feature provides the advantage in that the tissue paper is confined within normal boundaries of the cup, i.e. the boundaries the cup would have had the window not been formed in the outer layer.

In one variation, the window is defined by an upper edge of the outer layer material extending adjacent an upper end of the cup, a lower edge extending adjacent the lower end of the cup and a pair of side edges connecting the upper and the lower edges, the material of the outer layer between side edges defining a bridge portion of the outer layer extending longitudinally between the upper and the lower ends of the outer layer of the cup. In this arrangement, the cover sheet is secured to the outer layer at the bridge portion of the outer layer.

It will be appreciated that the cover sheet with the sheet of tissue paper secured to the inner face of the cover sheet as described above can be provided as a separate item.

In one arrangement, the first and the second longitudinal edges of the cover sheet are connected to form a ring which is sized and shaped so that it can be slipped longitudinally around the tubular wall of the cup in the manner of known cardboard insulating rings.

In one variation, the cover sheet comprises a generally C-shaped flap formed by making a generally C-shaped cut in the cover sheet, the flap being pivotable about a hinge, which can be in the form of e.g. a fold line, formed in the cover sheet material. In a preferred variation, the flap comprises a pair of lateral portions offset from the upper and the lower edges of the cover sheet and a longitudinal portion connecting the lateral portions at a first pair of ends of and the fold line extends between a second pair of ends of the lateral portions of the flap. At least a portion of the flap remote the hinge is preferably releasably fastened to the adjacent portion of the cover sheet material, i.e. the portion which would have been integral with the flap had the flap not been formed. In this modification, the size of the sheet of tissue paper is such that it is confined within the boundaries of the flap when fitted to the inner face of the flap. In one advantageous variation, the flap is initially secured to the cover sheet via a tear-line formed by forming a plurality of perforations along at least a portion of the perimeter of the flap. It will be appreciated that the flap can be arranged to be fully removable from the cover sheet, e.g. by forming the tear line along the entire perimeter of the flap.

In another variation, the first and the second portions of the cover sheet are not connected and instead a fastening means (e.g. an adhesive, such as a pressure-sensitive re-sealable adhesive) is provided at first and the second portion of the cover sheet, the portion being hingedly fastenable to the tubular wall of the cup and the second portion being releasably fastenable to either the tubular wall of the cup or the first portion of the cover sheet.

Preferably, the cover sheet comprises a fastening means (e.g. a pressure sensitive adhesive) around its entire perimeter. Such an arrangement holds the cover sheet in secure engagement with the tubular wall and maintains cleanliness of the tissue paper.

In one convenient arrangement, an elongate tab extends along a longitudinal edge of the cover sheet and is attached to the cover sheet along a detachment line, the detachment line extending substantially parallel the longitudinal edge, the elongate tab being detachable from the cover sheet along the detachment line and the elongate tab being sufficiently rigid to be capable of being used as a stirrer for a beverage upon detachment. The detachment line can be formed, for example, by forming a plurality of perforations in the cover sheet. Preferably, but not limited thereto, the elongate tab is made from the same material as the cover sheet.

Ideally, the cover sheet is die cut from a larger (than the cover sheet) sheet of the cover sheet material. Ideally, the larger sheet of the cover sheet material has a matching larger (than the sheet of tissue paper) sheet of tissue paper superposed over it and releasably secured thereto so that the cover sheet and the sheet of tissue paper are die cut in one step. In this aspect, the invention provides a method of making a cover sheet for an insulated cup comprising the steps of

providing a larger sheet of cover sheet material sized and shaped to allow at least one, and preferably a plurality of cover sheets to be die cut therefrom;

superposing a larger sheet of tissue paper over the sheet of cover sheet material, the larger sheet of tissue paper being sized and shaped to allow a cover sheet together with the sheet of tissue paper to be die cut in one step so that a layer of the tissue paper is superposed against the grippable area of the cover sheet.

Ideally, prior to die cutting a cover sheet from a larger sheet of cover sheet material, the method further comprises the step of securing the larger sheet of tissue paper to the larger sheet of cover sheet material using a securing means, the securing means being configured to keep the larger sheet of tissue paper attached to the larger sheet of cover sheet material during the method steps and at the same time to enable the tissue paper to be separated from the cover sheet by a user when required or desired without damaging the tissue paper. In one preferred arrangement, the larger sheet of tissue paper is secured to the larger sheet of cover sheet material by a non-permanent adhesive for easy removal and to avoid the risk of damage to the tissue paper. The adhesive is preferably provided in the form of one or more strips or a plurality of spots.

### DETAILED DESCRIPTION OF PREFERRED EMBODIMENTS

The invention will now be described with reference to the accompanying drawings which show, by way of example only, embodiments of an insulated cup and a cover sheet for a cup according to the invention. In the drawings:

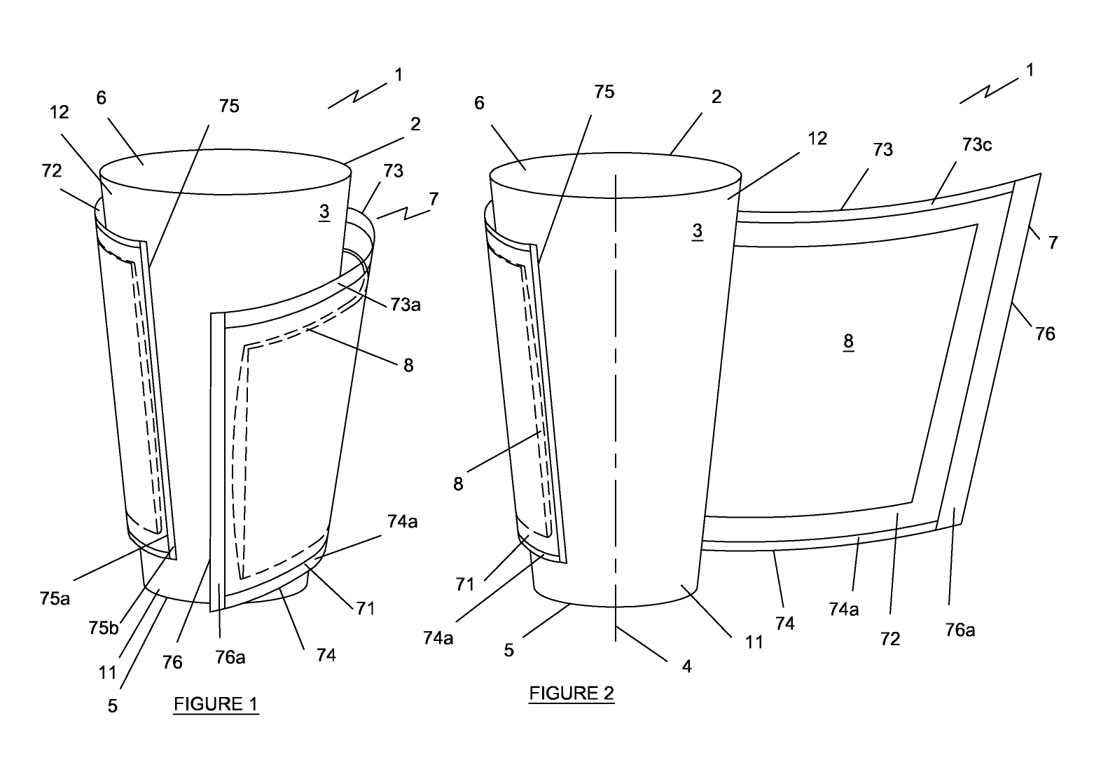

FIGS. 1 and 2 are schematic perspective views of a cup according to the invention in which a cover sheet in accordance with the invention partially wraps the cup;

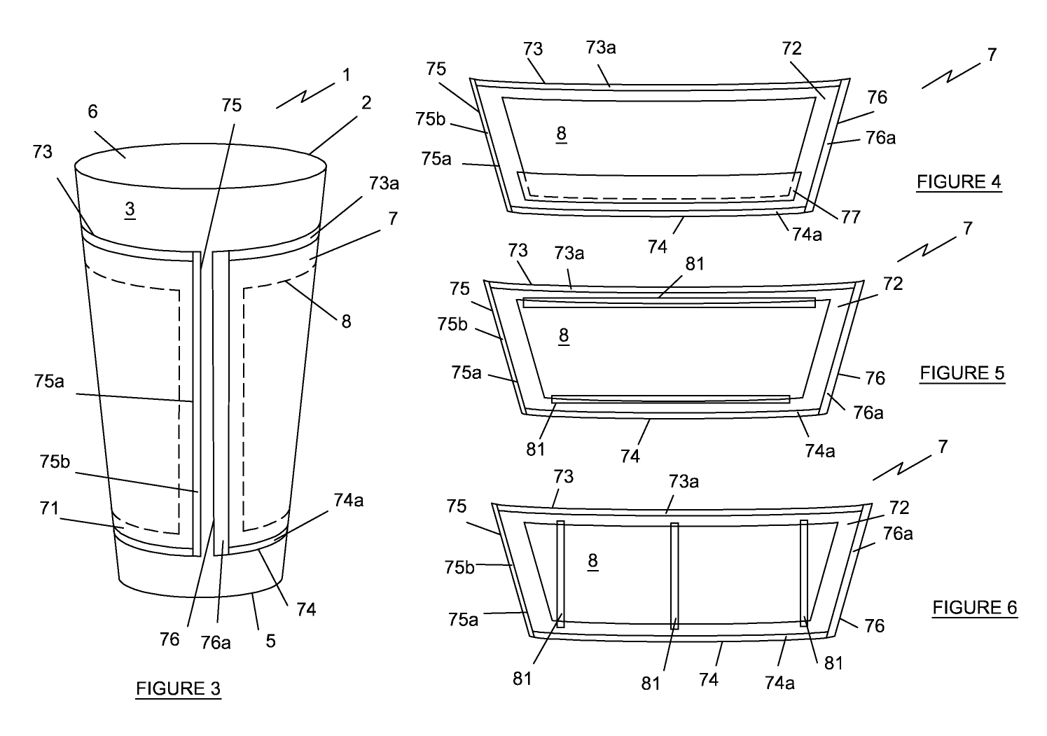

FIG. 3 is a schematic perspective view of the cup of FIGS. 1 and 2 in which the cover sheet fully wraps the cup;

FIGS. 4, 5 and 6 are schematic plan views of the inner face of a flattened cover sheet of the invention showing various exemplary arrangements for securing tissue paper to the cover sheet;

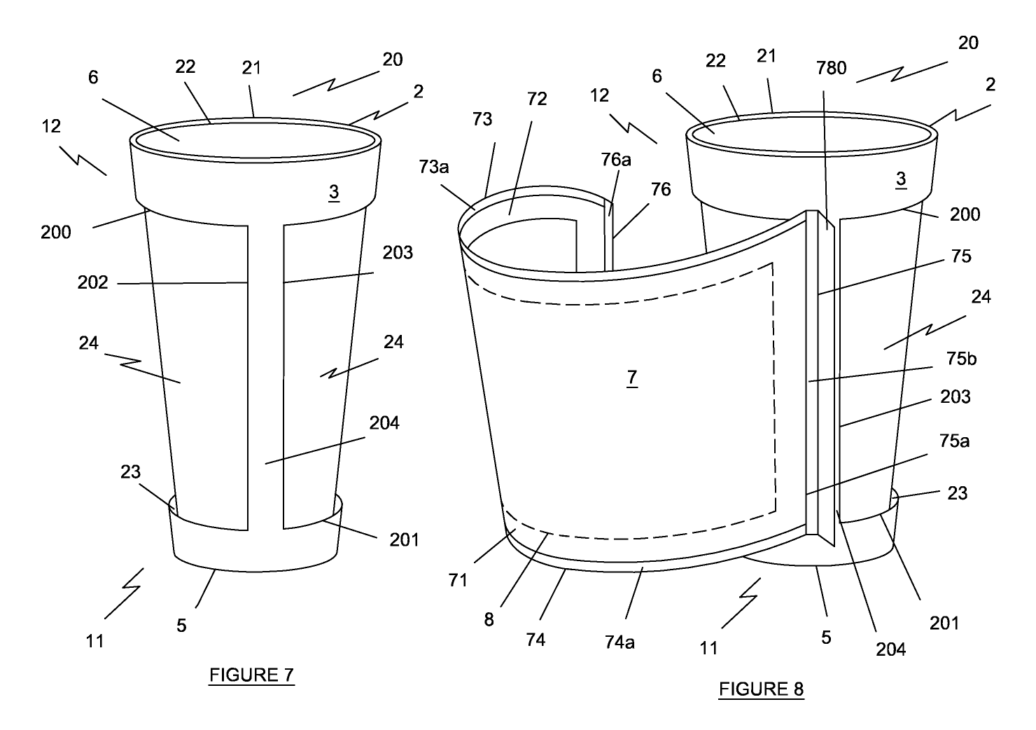

FIG. 7 is a schematic perspective view of a two-walled cup of the invention;

FIG. 8 is a schematic perspective view of the cup of FIG. 7 in which the cover sheet partially wraps the cup;

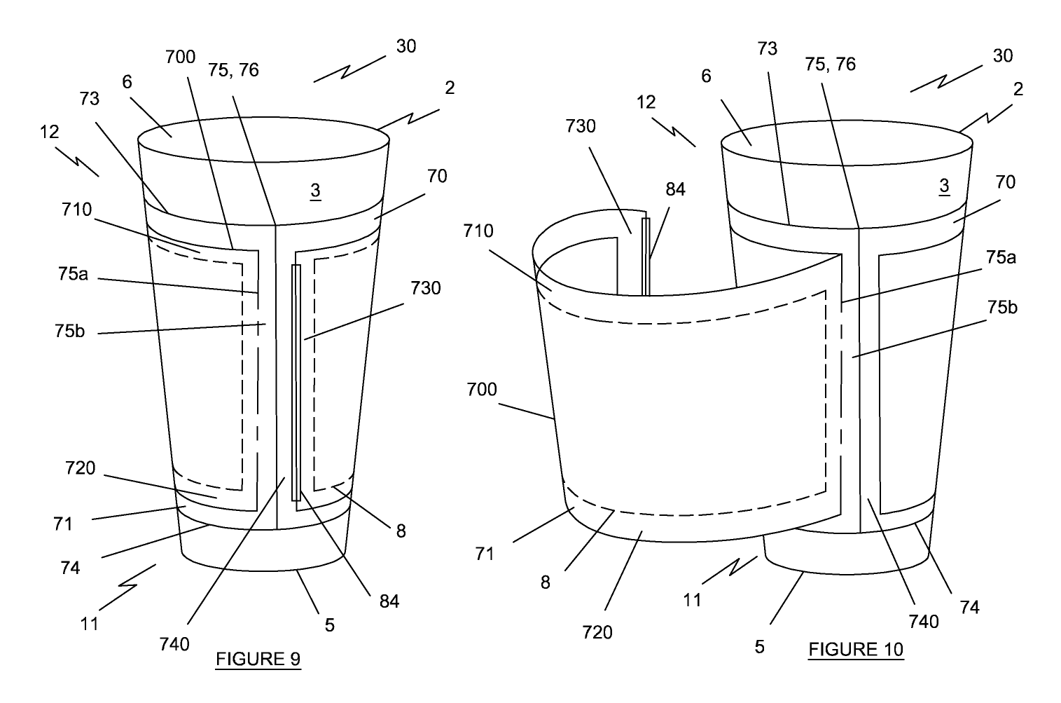

FIG. 9 is a schematic perspective view of a further embodiment of the cup and the cover sheet of the invention in which the cover sheet fully wraps the cup; and

FIG. 10 is a schematic perspective view of the cup of FIG. 9 in which the cover sheet partially wraps the cup.

Referring initially to FIGS. 1 to 3, a thermally insulated cup in accordance with one embodiment of the invention is indicated generally by reference numeral 1. The cup comprises a body 2 having the shape of an inverted truncated cone. The body 2 is preferably made from paperboard which is sufficiently rigid to retain its shape while holding the contents of the cup, e.g. a beverage or food. The body 2 of the cup 1 comprises a tubular wall 3 having a central longitudinal axis 4, a closed base 5 at a lower end 11 and an open top 6 defined at an upper end 12 of the cup 1.

The cup 1 further includes a cover sheet 7 preferably made from paper which is more flexible and which is thinner than the paperboard of which the body 2 of the cup 1 is made. In the embodiment of FIGS. 1 to 3, the cup 1 is supplied with the cover sheet 7 wrapped around the tubular wall 3 of the cup 1. The cover sheet 7 comprises an outer face 71 and an inner face 72, an upper edge 73, a lower edge 74 and a first and a second longitudinal edges 75, 76, respectively, defining the perimeter of the cover sheet. It will be appreciated that the cover sheet can also be made from another suitable material, such as paperboard or plastics. However it is preferred, that the material of the cover sheet is made from a recycled material, such as recycled paper or recycled paperboard, and uses less material than the tubular wall of the cup, i.e. it is thinner than the tubular wall of the cup.

The cover sheet 7 is hingedly secured to the tubular wall 3 along its first longitudinal edge 75 by forming a hinge in the form of a fold line 75a in the cover sheet 7 extending along and spaced apart from the first longitudinal edge 75 thereby defining a tab 75b; and by fastening the tab 75b to the tubular wall using a suitable adhesive applied to the inner face of the cover sheet 7. The adhesive can be, for example, but not limited thereto, a pressure-sensitive peelable and re-sealable adhesive, preferably made from a renewable material, or a permanent, i.e. non-peelable adhesive. It will be appreciated that a number of ways of hingedly fastening the portion of the cover sheet 7 adjacent the first longitudinal edge 75 to the tubular wall 3 would be apparent to a person skilled in the art.

A multi-ply sheet 8 of tissue paper is placed intermediate the inner face 72 of the cover sheet 7 and the tubular wall 3 so that the sheet 8 of tissue paper also wraps the tubular wall 3. The sheet 8 of tissue paper is sized so that on the one hand it is confined within the boundaries of the cover sheet 7. On the other hand, the size of the sheet 8 of tissue paper is such that a layer of the tissue paper is present under the grippable areas of the cover sheet. That is, when a user grips the cup, the areas of the cup under the user's fingers are positioned over the sheet 8 of the tissue paper underneath the cover sheet 7. In the cup of the present invention, the sheet 8 of tissue paper comprises several plies (not shown in the drawings). It will be appreciated that the sheet of tissue paper can be folded to increase the number of plies or several superposed sheets of tissue paper can be used, thereby enhancing the insulating properties of the cup 1. Due the presence of air between the plies, when the sheet 8 of tissue paper is interposed between the cover sheet 7 and the tubular wall 3 of the cup 1, the sheet 8 of tissue paper provides the cup 1 with excellent thermal insulation properties. Additionally, the cup 1 of the present invention becomes pleasant to grip because the tissue paper provides a cushioning effect due to the presence of the air between the plies of the tissue paper.

While providing excellent inexpensive and environmentally friendly layer of insulation, the sheet 8 of tissue paper is removable from underneath the cover sheet 7. The sheet 8 of tissue paper can be removed when required or desired and used for its direct purpose, namely personal hygiene or wiping a surface. The tissue paper may be removed for use for its direct purpose when the insulating properties of the cup 1 are no longer required, e.g. when the cup contents has reached a comfortable for the user temperature or when the user does not need to hold the cup for a time interval long enough to cause a thermal discomfort or, indeed, at any time when required or desired by a user. The cover sheet 7 is re-placeable into the position in which it wraps the tubular wall 3.

The cover sheet 7 is releasably fastened to the tubular wall 3 along at least the second longitudinal edge 76 of the cover sheet 7 by a fastening means. The fastening means can be in the form of a layer of a pressure-sensitive peelable and re-sealable adhesive applied a portion of the inner face 72 of the cover sheet 7 extending adjacent the second longitudinal edge 76 of the cover sheet 7. It will be appreciated that many ways of releasably and re-fastenably fastening the cover sheet 7 to the tubular wall 3 would be apparent to a person skilled the art. The upper and the lower edges 73, 74, respectively, of the cover sheet 7 are also preferably releasably re-fastenably fastened to the tubular wall 3 by, for example, applying the adhesive to portions 73a, 74a of the inner face 72 of the cover sheet 7 extending adjacent the upper and the lower edges 73, 74, respectively. Due to such an arrangement, the cleanliness of the sheet of tissue paper is maintained uncompromised until the cover sheet 7 is unfastened for the first time form the tubular wall 3.

Alternatively, although not shown in the drawings, some or all of the upper and lower edges 73, 74 and the first ad second longitudinal edges 75, 76 can be fastened to the tubular wall 2 by one or more peelable and re-sealable adhesive strips, but the invention is not in any way limited to this arrangement.

Further alternatively, although not shown in the drawings, the portion 76b of the cover sheet 7 adjacent the second longitudinal edge 76 is releasably fastened to the portion 75b of the cover sheet 7 adjacent the first longitudinal edge 75, which in turn is fastened to the tubular wall 2.

In the presently described embodiments, in order to remove the tissue paper, the second longitudinal edge 76 of the cover sheet 7, and, if applicable, the upper and the lower edges 73, 74, are unfastened and the cover sheet 7 is spread apart from the tubular wall 3 of the cup 1 by a sufficient distance to enable the user remove the tissue paper. The cover sheet 7 can be replaced into the position in which it wraps the tubular wall 3 by pivoting the cover sheet 7 in the reverse direction and re-fastening the portion 76a adjacent the second longitudinal edge 76 to the tubular wall 3.

Despite being preferably thinner than the paperboard material of the tubular wall 3, the thickness of the paper material of the cover sheet 7 is sufficient to provide the cup 1 with thermal insulation properties, if not as substantial as those provided for by the combination of the cover sheet 7 and the sheet 8 of tissue paper but nevertheless greater than provided for by the paperboard material of the tubular wall 3 alone and sufficient to prevent the user from experiencing thermal discomfort while holding the cup 1 of the invention.

The sheet 8 of tissue paper need not necessarily be secured to the cover sheet 7 or the tubular wall 3 since (as shown in FIG. 3) it is held in its position intermediate the cover sheet 7 and the tubular wall 3 due to friction forces between the tissue paper and each of the cover sheet 7 and the tubular wall 3. In a preferred arrangement however, as shown in FIGS. 4, 5 and 6, the sheet 8 is releasably secured to the cover sheet 7 at the inner face 72 of the cover sheet by a securing means so that the sheet 8 can be easily detached from the cover sheet 7 without damaging the tissue paper. As shown in FIG. 4, a pocket 77 is provided at the inner face 72 of the cover sheet 7 suitably shaped for holding the sheet 8. As shown in FIG. 5, the sheet 8 is held secured to the inner face 72 of the cover sheet 7 by adhesive strips 81. Each strip 81 is partially adhered to the sheet 8 and partially peelably adhered to the inner face 72 of the cover sheet 7, so that the sheet 8 can be easily detached from the inner face 72 of the cover sheet 7. In a variation shown in FIG. 6, bracket members 82 are provided at the inner face 72 of the cover sheet 7 extending between the upper and the lower edges 73, 74 of the cover sheet 7 and the sheet 8 of tissue paper is slipped between the bracket members 82 and the inner face 72 of the cover sheet 7. It will be appreciated that a number of ways of releasably securing the sheet of tissue paper to the inner face 72 of the cover sheet 7 or on the outwardly facing face of the tubular wall 3 would be readily apparent to a person skilled in the art. For example, although not shown in the drawings, an advantageous arrangement includes providing a layer of an adhesive between the inner face 72 of the cover sheet 7 and the sheet 8 of tissue paper. The adhesive is sufficiently strong to hold the sheet 8 of tissue paper in engagement with the cover sheet 7 and yet sufficiently weak to enable easy detachment of the sheet 8 of tissue paper from the cover sheet 7 substantially without damaging the tissue paper.

Referring to FIGS. 7 and 8, a further embodiment of the cup in accordance with one embodiment of the invention is indicated generally by reference numeral 20. The cup 20 is similar to the cup 1 of FIGS. 1 to 3 and elements of the cup 20 common to both cups 1 and 20 have been indicated using the same reference numerals. The tubular wall 2 of the cup 20 is formed by a pair of concentric tubular layers of paperboard, an outer layer 21 and an inner layer 22 radially spaced apart to define an insulation gap 23 therebetween. A window 24 is formed in the outer layer 21. The area of the window 24 is greater than the area of the remaining outer layer 21 material. The window 24 and the cover sheet 7 are mutually sized and shaped so that the cover sheet 7 covers the window 24 completely when the cover sheet 7 wraps the tubular wall 2 of the cup 20, i.e. the portions of the outer layer 21 which define the window 24 are confined within the boundaries of the cover sheet 7. The window 24 is defined by an upper edge 200 of the outer layer material extending adjacent an upper end 12 of the cup 20, a lower edge 201 extending adjacent the lower end 11 of the cup 20 and by a pair of side edges 202, 203 connecting the upper and the lower edges 200, 201. The material of the outer layer 21 between side edges 202, 203 defines a bridge portion 204 of the outer layer 21 extending longitudinally between the upper and the lower edges 200, 201 of the outer layer 21 of the cup 20. In this arrangement, the portions 75b and 76a adjacent the first and the second longitudinal edges 75, 76, respectively of the cover sheet 7 are secured to the outer layer 21 at the bridge portion 204 of the outer layer 21. The upper and the lower edges 73, 74, respectively, of the cover sheet 7 are secured to the outer layer 21 along the upper and the lower edges 200, 201 of the outer layer 21, respectively. In this arrangement, the sheet 8 of tissue paper is accommodated in the gap 23 between the inner layer 22 of the tubular wall 7 of the cup 20 and the inner face 72 of the cover sheet 7.

Still referring to FIGS. 7 and 8, an elongate tab 780 extends along the longitudinal edge 75 of the cover sheet 7 and is attached thereto along a detachment line which in FIG. 8 coincides with the longitudinal edge 75. The detachment line is formed, for example, by forming a plurality of perforations (not shown) in the cover sheet 7 along the longitudinal edge 75. The elongate tab 780 is detachable from the cover sheet 7 along the detachment line. The elongate tab 780 is sufficiently rigid to be capable of being used as a stirrer for a beverage upon detachment from the cover sheet. Preferably, but not limited thereto, the elongate tab 780 is made from the same material as the cover sheet 7.

It will be appreciated that the cover sheet 7 with the sheet 8 of tissue paper secured to the inner face 8 of the cover sheet 7 as described above with reference to FIGS. 1 to 8 can be provided as a separate item.

A cup 30 is shown in FIGS. 9 to 10 is similar to the cup 1 of FIGS. 1 to 3 and elements of the cup 30 common to both cups 1 and 30 have been indicated using the same reference numerals. The cover sheet on the cup 30 indicated generally by reference numeral 70 is similar to the cover sheet 7 described above and elements of the cover sheet 70 common to both cover sheets 7 and 70 have been indicated using the same reference numerals. The first and the second longitudinal edges 75, 76 of the cover sheet 70 are connected to form a ring which is sized and shaped so that it can be slipped longitudinally around the tubular wall 3 of the cup in the manner of a known cardboard insulating ring.

The cover sheet 70 comprises a generally C-shaped flap 700 formed by making a generally C-shaped cut in the cover sheet 70. The flap 700 ifs defined by a pair of lateral portions 710, 720 offset from the upper and the lower edges 73, 74, respectively, of the cover sheet 70 and a longitudinal portion 730 connecting a first pair of ends of the lateral portions 710, 720. The flap 700 is pivotable about a hinge in form of a fold line 75a line formed in the cover sheet material. The fold line 75a extends between the second pair of ends of the lateral portions 710, 720 of the flap. The longitudinal portion 730 of the flap 700 is preferably releasably fastened to the matching portion 740 of the cover sheet 70, i.e. the portion which would have been integral with the longitudinal portion 730 of the flap 700 had the flap 700 not been formed. In one arrangement, the size of the sheet 8 of tissue paper is such that it is confined within the boundaries of the flap 700 when fitted to the inner face 72 of the flap 700. In another variation, the sheet 8 of tissue paper is of substantially the same size as the cover sheet 7. In one arrangement, when the flap 700 is pivoted away from the cover sheet, the tissue paper is arranged to remain superposed over the tubular wall 3 and can be pinched to be removed. In another arrangement, he tissue paper is attached to the flap 700 and is pivoted away from the cover sheet 7 and the tubular wall 3 when the flap 700 is pivoted. Although not shown in the drawings, the lateral portions of the flap 700 are preferably also releasably fastened to the matching regions of the upper and lower portions 73, 74 of the cover sheet 70. Furthermore, in another arrangement, the flap 700 is releasably fastened to the cover sheet 7 along a closed perimeter. The flap 700 is preferably fastened via a tear-line formed by a plurality of perforations in the cover sheet 7. It will be appreciated that the flap 700 arrangement can be used with any of the embodiments of the cover sheet 7 or cup 1, 20, 30 herein described.

According to a method of the present invention, although not shown in the drawings, the cover sheet 7 is die cut from a larger sheet of the cover sheet material which has a matching larger sheet of tissue paper superposed over it and releasably secured thereto so that the cover sheet 7 and the sheet 8 of tissue paper are die cut in one step. The larger sheet of cover sheet material is sized and shaped to allow at least one, and preferably a plurality of cover sheets 7 to be die cut therefrom. The larger sheet of tissue paper is superposed over the larger sheet of cover sheet material and is sized and shaped to allow a cover sheet 7 together with the sheet 8 of tissue paper to be die cut in one step so that a layer of tissue paper is superposed against the grippable area of the cover sheet 7.

According to the method of the present invention, prior to die cutting, the larger sheet of tissue paper is secured to the larger cover sheet using a securing means configured to keep the larger sheet of tissue paper engaged with the larger sheet of cover sheet material during die cutting. At the same time, the securing means is configured to enable the sheet 8 of tissue paper to be separated from the cover sheet 7 by a user when required or desired. Preferably, the securing means comprises a non-permanent adhesive, provided, for example, in the form of one or more strips or a plurality of spots.

In another variation not shown in the drawings, the first and the second longitudinal edges 75, 76 of the cover sheet 7, 70 are not connected and instead a fastening means (e.g. an adhesive, such as a pressure-sensitive re-sealable adhesive) is provided at least at the first and the second longitudinal edges 75, 76 of the cover sheet 70, a first edge 75 being hingedly fastenable to the tubular wall 3 of the cup 1,20, 30 and the second longitudinal edge 76 being releasably fastenable to either the tubular wall 3 of the cup 1, 20, 30 or the first longitudinal edge 75 of the cover sheet 7, 70.

It will be appreciated by those skilled in the art that variations and modifications can be made without departing from the scope of the invention as defined in the appended claims.

1. A cover sheet for thermally insulating a cup, the cup being made from a material which is sufficiently rigid to retain its shape while holding the contents of the cup, the cup comprising a tubular wall having a central longitudinal axis, a closed base at a lower end and an open top defined at an upper end of the cup, the cover sheet comprising
an outer face and an inner face and a grippable area on the outer face;
wherein a multi-ply sheet of tissue paper is provided at the inner face of the cover sheet;
the cover sheet being configured to be placed around the tubular wall of the cup.

2. A cover sheet as claimed in claim 1, wherein the sheet of tissue paper is sized so that on the one hand it is confined within the boundaries of the cover sheet, and on the other hand the size of the sheet of tissue paper is such that a layer of the tissue paper is present under the grippable area of the cover sheet.

3. A cover sheet as claimed in claim 1, wherein sheet of the tissue paper comprises one or more plies.

4. A cover sheet as claimed in claim 1, wherein the sheet of tissue paper is folded to increase the number of plies.

5. A cover sheet as claimed in claim 1, wherein the sheet of tissue paper is larger than the cover sheet and is folded to reduce its size so that it is confined within the boundaries of the cover sheet when the sheet of tissue paper is placed at the inner face of the cover sheet.

6. A cover sheet as claimed in claim 1, wherein the sheet of tissue paper is removably placed at the inner face of the cover sheet.

7. A cover sheet as claimed in claim 1, wherein the cover sheet comprises a portion pivotable about a hinge to enable at least a portion of the cover sheet to be pivoted.

8. A cover sheet as claimed in claim 1, wherein the cover sheet comprises an upper edge, a lower edge and first and second longitudinal edges defining the perimeter of the cover sheet.

9. A cover sheet as claimed in claim 1, wherein, the material of the cover sheet is made from a recycled material.

10. A cover sheet as claimed in claim 1, wherein the material of the cover sheet comprises recycled paper or recycled paperboard.

11. A cover sheet as claimed in claim 8, wherein the first and the second longitudinal edges of the cover sheet are connected to form a ring which is sized and shaped so that it can be slipped longitudinally around a tubular wall of a cup.

12. A cover sheet as claimed in claim 1, wherein the cover sheet comprises a generally C-shaped flap formed by making a generally C-shaped cut in the cover sheet, the flap being pivotable about a hinge.

13. A cover sheet as claimed in claim 12, wherein the hinge is in the form of a fold line formed in the cover sheet material.

14. A cover sheet as claimed in claim 13, wherein the flap comprises a pair of lateral portions offset from the upper and the lower edges of the cover sheet and a longitudinal portion connecting the lateral portions at a first pair of ends of and the fold line extends between a second pair of ends of the lateral portions of the flap.

15. A cover sheet as claimed in claim 12, wherein at least a portion of the flap remote the hinge is releasably fastened to the adjacent portion of the cover sheet material.

16. A cover sheet as claimed in claim 15, wherein the size of the sheet of tissue paper is such that it is confined within the boundaries of the flap when fitted to the inner face of the flap.

17. A cover sheet as claimed in claim 12, the flap is initially secured to the cover sheet via a tear-line formed by forming a plurality of perforations along at least a portion of the perimeter of the flap.

18. A cover sheet as claimed in claim 17, wherein the tear line is formed along the entire perimeter of the flap.

19. A cover sheet as claimed in claim 1, wherein the first and the second portions of the cover sheet are not connected and instead a fastening means is provided at the first and the second portions of the cover sheet, the first portion being hingedly fastenable to the tubular wall of the cup and the second portion being releasably fastenable to either the tubular wall of the cup or the first portion of the cover sheet.

20. A cover sheet as claimed in claim 1, wherein the cover sheet comprises a fastening means around its entire perimeter.

21. A cover sheet as claimed in claim 1, wherein an elongate tab extends along a longitudinal edge of the cover sheet and is attached to the cover sheet along a detachment line, the detachment line extending substantially parallel to the longitudinal edge, the elongate tab being detachable from the cover sheet along the detachment line and the elongate tab being sufficiently rigid to be capable of being used as a stirrer for a beverage upon detachment.

22. A cover sheet as claimed in claim 21, wherein the detachment line is formed by forming a plurality of perforations in the cover sheet.

23. A cover sheet as claimed in claim 21, wherein the elongate tab is made from the same material as the cover sheet.

24. A cover sheet as claimed claim 1, wherein the cover sheet is die cut from a larger (than the cover sheet) sheet of the cover sheet material, wherein the larger sheet of the cover sheet material has a matching larger (than the sheet of tissue paper) sheet of tissue paper superposed over it and releasably secured thereto so that the cover sheet and the sheet of tissue paper are die cut in one step.

25. A cover sheet as claimed in claim 24, wherein the larger sheet of tissue paper is secured to the larger sheet of cover sheet material by a non-permanent adhesive for easy removal and to avoid the risk of damage to the tissue paper.

26. A cover sheet as claimed in claim 25, wherein the adhesive is provided in the form of one or more strips or a plurality of spots.

27. A cover sheet as claimed claim 1, wherein the cover sheet is wrapped around a tubular wall of a cup made from a material which is sufficiently rigid to retain its shape while holding the contents of the cup, the cup comprising the tubular wall which has a central longitudinal axis, a closed base at a lower end and an open top defined at an upper end of the cup, wherein the multi-ply sheet of tissue paper is placed intermediate the inner face of the cover sheet and the tubular wall so that the sheet of tissue paper wraps the tubular wall.

28. A cover sheet as claimed in claim 27, wherein the material of the cup is paperboard.

29. A cover sheet as claimed in claim 27, wherein at least a first portion of the cover sheet is hingedly secured to the tubular wall; and wherein at least a second portion of the cover sheet is releasably fastened to the tubular wall or the cover sheet via a fastening means.

30. A cover sheet as claimed in claim 29, wherein a first portion of the cover sheet is adjacent a first longitudinal edge, at least a second portion of the cover sheet is adjacent at least the second longitudinal edge.

31. A cover sheet as claimed in claim 30, wherein the cover sheet is releasably fastened to the tubular wall substantially along the entire perimeter of the cover sheet

32. A cover sheet as claimed in claim 29, wherein the releasable fastening means is re-fastenable to the tubular wall of the cup.

33. A cover sheet as claimed in claim 29, wherein the cover sheet is fastened to the tubular wall by a layer of a pressure-sensitive peelable and re-sealable adhesive on the inner face of the cover sheet on or adjacent the second portion of the cover sheet or on the corresponding area of the tubular wall.

34. A cover sheet as claimed in claim 29, wherein the cover sheet is fastened to the tubular wall by a layer of a permanent adhesive.

35. A cover sheet as claimed in claim 29, wherein the portions of the cover sheet are fastened to the tubular wall by one or more adhesive strips.

36. A cover sheet as claimed in claim 29, wherein the second portion of the cover sheet is releasably fastened to the tubular wall by fastening the second portion to the first portion of the cover sheet which itself is at least partially fastened to the tubular wall.

37. A cover sheet as claimed in claim 29, wherein the first portion of the cover sheet is hingedly secured to the tubular wall by fastening the first portion of the cover sheet to the tubular wall and by forming a hinge in the form of a fold line in the cover sheet extending along the fastened region of the first portion of the cover sheet.

38. A cover sheet as claimed in claim 29, wherein the first portion of the cover sheet is fastened to the tubular wall using an adhesive.

39. A cover sheet as claimed in claim 27, wherein the cover sheet is made from a material more flexible than the material of the tubular wall.

40. A cover sheet as claimed in claim 27, wherein the cover sheet is made from a material which is thinner than the material of which the cup is made.

41. A cover sheet as claimed in claim 27, wherein the sheet of tissue paper is held in its position intermediate the cover sheet and the tubular wall due to friction forces between the tissue paper and each of the cover sheet and the tubular wall.

42. A cover sheet as claimed in claim 27, wherein the sheet of tissue paper is releasably secured to the cover sheet or the tubular wall of the cup by a securing means so that the sheet of tissue paper can be easily removed from its position intermediate the cover sheet and the tubular wall without damaging the tissue paper.

43. A cover sheet as claimed in claim 42, wherein a pocket or tab or bracket members are formed at the inner face of the cover sheet or on the outwardly facing face of the tubular wall suitably shaped for holding the sheet of tissue paper.

44. A cover sheet as claimed in claim 42, wherein the sheet of tissue paper is held secured to the inner face of the cover sheet or on the outwardly facing face of the tubular wall by adhesive tabs or strips, wherein such a tab or a strip is partially adhered to the sheet of tissue paper and partially peelably adhered to the inner face of the cover sheet or the outwardly facing face of the tubular wall.

45. A cover sheet as claimed in claim 42, wherein the sheet of tissue paper is adhered to the inner face of the cover sheet of the outwardly facing face of the tubular wall by a layer of an adhesive provided between the sheet of tissue paper and the cover sheet or the outwardly facing face of the tubular wall.

46. A cover sheet as claimed in claim 45, wherein the adhesive force is such that it is sufficient to hold the sheet of tissue paper attached to the cover sheet or the tubular wall, respectively, but is sufficiently weak so that the sheet of tissue paper can be separated from the cover sheet or the tubular wall without being damaged.

47. A cover sheet as claimed in claim 27, wherein the tubular wall of the cup is formed by a pair of concentric tubular layers an outer layer and an inner layer radially spaced apart to define an insulation gap therebetween.

48. A cover sheet as claimed in claim 47, wherein the cover sheet comprises the outer layer.

49. A cover sheet as claimed in claim 47, wherein a window is formed in the outer layer, the area of the window being greater than the area of the remaining outer layer material.

50. A cover sheet as claimed claim 47, wherein the window and the cover sheet are mutually sized and shaped so that the cover sheet covers the window when the cover sheet wraps the tubular wall of the cup, wherein the first portion of the cover sheet is hingedly secured to the remaining material of the outer layer and wherein the second portion of the cover sheet is releasably fastened to the remaining material of the outer layer via a fastening means.

51. A cover sheet as claimed in claim 47, wherein the sheet of tissue paper is accommodated in the gap defined between the inner layer of the tubular wall of the cup and the inner face of the cover sheet.

52. A cover sheet as claimed in claim 49, wherein the window is defined by an upper edge of the outer layer material extending adjacent an upper end of the cup, a lower edge extending adjacent the lower end of the cup and a pair of side edges connecting the upper and the lower edges, the material of the outer layer between side edges defining a bridge portion of the outer layer extending longitudinally between the upper and the lower ends of the outer layer of the cup.

53. A cover sheet as claimed in claim 52, wherein the cover sheet is secured to the outer layer at the bridge portion of the outer layer.

54. A method of making a cover sheet for an insulated cup comprising the steps of
providing a larger sheet of cover sheet material sized and shaped to allow one or more cover sheets to be die cut therefrom; and
superposing a larger sheet of tissue paper over the sheet of cover sheet material, the larger sheet of tissue paper being sized and shaped to allow a cover sheet together with the sheet of tissue paper to be die cut in one step so that a layer of the tissue paper is superposed against the grippable area of the cover sheet.

55. A method of claim 54 comprising the step of
prior to die cutting a cover sheet from a larger sheet of cover sheet material, securing the larger sheet of tissue paper to the larger sheet of cover sheet material using a securing means, the securing means being configured to keep the larger sheet of tissue paper attached to the larger sheet of cover sheet material during the method steps and at the same time to enable the tissue paper to be separated from the cover sheet by a user when required or desired without damaging the tissue paper.

56. A method of claim 55 comprising the step of
securing the larger sheet of tissue paper to the larger sheet of cover sheet material comprises using a non-permanent adhesive for easy removal and to avoid the risk of damage to the tissue paper.

57. A method of claim 56 further comprising the step of providing the adhesive in the form of one or more strips or a plurality of spots.
